(19) United States
(12) Patent Application Publication
(10) Pub. No.: US 2026/0127682 A1
(43) Pub. Date: May 7, 2026

(54) SYSTEMS AND METHODS FOR ALERTING TAX PROFESSIONALS ON INCOMING TAX REGULATORY CHANGES

(71) Applicants: Thomson Reuters Enterprise Centre GmbH, Zug (CH); Thomson Reuters International Services Private Limited, Mumbai (IN)

(72) Inventors: Adrian Alan Pol, Zug (CH); Stavroula Skylaki, Zug (CH); Krishna Chaitanya Reddy, V, Whitefield (IN); Palvika Bansal, Whitefield (IN); Guglielmo Bonifazi, Zurich (CH)

(21) Appl. No.: 19/381,571

(22) Filed: Nov. 6, 2025

Related U.S. Application Data
(60) Provisional application No. 63/717,067, filed on Nov. 6, 2024.

(51) Int. Cl. G06Q 40/10; G06F 16/334

(52) U.S. Cl. CPC G06Q 40/10; G06F 16/3346

(57) ABSTRACT

A system and method of tax regulatory change management is provided, comprising: receiving tax filing instructions and e-file schemas of tax forms; converting the filing instructions into output filing instructions and the e-file schemas into output e-file schemas; executing a mapping operation to generate an instruction-to-schema mapping; executing a tax form descriptions operation that generates form descriptions and per-line descriptions of each of the tax forms from the instruction-to-schema mapping using a first generative model; receiving a tax article identifying a tax regulation change; executing an impacted forms operation that uses the form descriptions and the identified tax regulation change as inputs to a second generative model that identifies an impacted tax form; executing an impacted lines operation that uses a third generative model to identify an impacted line from the impacted form; and generating a notification including the impacted line in the impacted form.

### RELATED APPLICATIONS

This application is related to and claims priority to provisional application Ser. No. 63/717,067, entitled “SYSTEMS AND METHODS FOR ALERTING TAX PROFESSIONALS ON INCOMING TAX REGULATORY CHANGES,” filed on Nov. 6, 2024, the entire contents of which being expressly incorporated herein by reference.

### FIELD

The present disclosure pertains to the field of tax regulation monitoring, and more particularly to systems and methods for alerting tax professionals of incoming tax regulatory changes and providing personalized notifications without compromising end user data privacy.

### BACKGROUND

Tax regulatory changes can significantly impact businesses'financial and legal situations. Tax regulations are subject to frequent modifications by government authorities to address evolving economic conditions, promote specific policies, or adjust the tax system. For example, the Tax Cuts and Jobs Act of 2017 had many consequences for corporations and individuals in multiple jurisdictions.

Tax professionals face challenges that can be broadly categorized into two groups. First, staying informed about tax regulatory changes is essential for providing accurate and up-to-date advice to individuals and businesses navigating the complex tax landscape. Tax laws and regulations are subject to frequent updates and modifications, occurring more often than annually. These changes can occur at various levels of government, including federal, state, and local jurisdictions. Second, correctly acting on changes to tax regulations is a complex and intricate task that requires a high degree of expertise and thoughtfulness.

There are thousands of U.S. tax forms, schedules, and instructions to process to understand the full implications of tax regulation changes. This high volume of tax regulations, guidance, and rulings issued by various government agencies, such as the Internal Revenue Service and state tax authorities, is problematic. Extracting relevant updates from this vast amount of information is time-consuming. Tax professionals have busy schedules, especially during peak tax seasons. Many jurisdictions require tax professionals to complete educational courses or obtain certifications to maintain their licenses or credentials. This mitigates the issue of staying up to date, but does not eliminate it entirely. Finding time to review and comprehend tax regulation updates is difficult within limited timeframes amidst other professional obligations of tax professionals.

Additionally, tax laws and regulations are complex, with intricate details, nuances, and implications that involve numerous exceptions, special cases, and interrelated provisions. Moreover, they vary significantly across different jurisdictions.

Tax professionals must be aware of these differences when working with clients whose businesses are present in multiple jurisdictions.

Finally, even after identifying relevant updates, understanding the implications and their interpretation of how to apply them correctly to specific client situations is non-trivial. Inaccurate interpretation of tax regulation can result in fines and penalties for the parties involved or other negative financial implications. When relevant tax legislation is overlooked, it may result in the incorrect amount of tax paid, which could have monetary or legal consequences for the individuals, businesses and organizations involved.

Tax professionals attempt to address the above challenges by relying on diverse strategies such as attending seminars and workshops, subscribing to professional publications and online resources, networking with peers, and seeking guidance from other tax experts or professional organizations. A human-centric approach relies on a manual review of incoming changes and their relevance to the customer base. This is a time-consuming process that is prone to errors and lacks scalability for large data volumes. Additionally, it may introduce inconsistencies due to individual biases and varying levels of expertise among human experts. Notification services, seminars and workshops lack personalization, breadth of information, and real-time adaptability. These methods often provide generic information that may not address specific taxpayer needs.

Regarding potential automated strategies for addressing the above-described challenges, rule-based automation systems, although capable of handling straightforward compliance checks, struggle with ambiguity in regulatory language and require frequent manual rule amendments. Collaborative filtering relies heavily on other users'data and thus causes a competitive advantage issue. It can replace human tax advisors with algorithms that can scale to a large data volume but at the cost of sharing companies'data. Additionally, it can create echo chambers that focus only on some changes and limit exposure to uncommon cases. Directly matching client data with regulatory change through a similarity indicator is a straightforward solution, but it also carries computational complexity scaling linearly with the number of clients and regulation changes. Finally, vanilla multi-label classification (i.e., matching changes to specific tax forms with a machine learning model), is an efficient alternative to the above, where the computational complexity depends only on the number of regulation changes. However, the method still lacks contextual information (e.g., filing instructions), which are desirable for the end user.

Accordingly, it is desirable to provide a system and method for alerting tax professionals of incoming tax regulatory changes and providing personalized notifications with justifications and without compromising the data privacy of end users.

### SUMMARY

In one embodiment, the present disclosure provides a method of tax regulatory change management, comprising: receiving, by one or more processors, tax filing instructions from a tax filing instructions database; receiving, by the one or more processors, e-file schemas of tax forms from a tax form schemas database; executing, by the one or more processors, a text extraction operation to convert the tax filing instructions into output tax filing instructions having a text format; executing, by the one or more processors, a preprocessing operation to append an identifier to each line of the tax forms of the e-file schemas and convert the e-file schemas into output e-file schemas; executing, by the one or more processors, a mapping operation to generate an instruction-to-schema mapping by mapping the output tax filing instructions to the output e-file schemas, wherein the output tax filing instructions form a corpus and the output e-file schemas form queries; executing, by the one or more processors, a tax form descriptions operation that generates form descriptions and per-line descriptions of each of the tax forms from the instruction-to-schema mapping using a first generative model for each of the tax forms; receiving, by the one or more processors, a tax article identifying a tax regulation change; executing, by the one or more processors, an impacted forms operation that uses the form descriptions and the identified tax regulation change as inputs to a second generative model that identifies at least one impacted tax form; executing, by the one or more processors, an impacted lines operation that uses a third generative model to identify at least one impacted line from the at least one impacted form; and generating, by the one or more processors, a notification to a user on an interface, the notification including the at least one impacted line in the at least one impacted form. In one aspect of this embodiment, the text extraction operation uses a rules-based extraction tool. In another aspect, the output e-file schemas are in a JSON format. In another aspect, the mapping operation employs a BM25 algorithm to generate the instruction-to-schema mapping. In a variant of this aspect, the BM25 algorithm ranks the output tax filing instructions to generate the instruction-to-schema mapping. In another aspect, the method further comprises executing, by the one or more processors, a filtering operation on the instruction-to-schema mapping, the output tax filing instructions and the output e-file schemas. In another aspect, the first generative model generates the per-line descriptions in batches of lines for the lines of the tax forms. In yet another aspect, the form descriptions are stored in a form description database and the per-line descriptions are stored in a pre-line description database. A variant of this aspect further comprises executing, by the one or more processors, a context documents operation that uses article metadata to retrieve only relevant form descriptions from the form description database. In still another aspect, the method further comprises executing, by the one or more processors, a long article generation operation that uses a fourth generative model to expand the tax article when a length of the tax article is below a predetermined threshold. In a variant of this aspect, the third generative model identifies the at least one impacted line by determining which lines in the per-line descriptions are impacted by the expanded tax article. In another aspect, the impacted forms operation performs a hallucination check by comparing the at least one impacted tax form to a predefined list of tax forms for a jurisdiction and filtering out the at least one impacted tax form when it does not appear on the predefined list of tax forms. In another aspect, the second generative model generates a rationale for identifying the at least one impacted form for display in the notification. In yet another aspect, the second generative model assigns a confidence level to the at least one impacted form based on a relevance of the tax regulation change to the at least one impacted form. In another aspect, the third generative model generates a rationale for identifying the at least one impacted line for display in the notification. In another aspect, the third generative model assigns a confidence level to the at least one impacted line based on a relevance of the tax regulation change to the at least one impacted line. In another aspect, the method further comprises matching, by the one or more processors, historical filings of the user with tax regulation changes using user data, the at least one impacted form and the at least one impacted line. In another aspect, the notification includes a listing of searchable tax articles in a tax regulation insights panel. In a variant of this aspect, when a tax article in the tax regulation insights panel is selected by the user, a title and text of the selected tax article are displayed in an article pane of the notification. In another aspect, the notification includes an impacted forms pane having a list of impacted tax forms and impacted lines corresponding to the list of impacted tax forms. In a variant of this aspect, the impacted forms pane further includes an information icon which, when selected by the user, causes the one or more processors to generate insights related to an impacted line corresponding to the information icon for display on the interface.

In another embodiment, the present disclosure provides a system for tax regulatory change management, comprising: a memory including a plurality of generative models and a plurality of instructions; one or more processors coupled to the memory and configured to execute the instructions to perform a plurality of functions, including: receiving tax filing instructions from a tax filing instructions database; receiving e-file schemas of tax forms from a tax form schemas database; executing a text extraction operation to convert the tax filing instructions into output tax filing instructions having a text format; executing a preprocessing operation to append an identifier to each line of the tax forms of the e-file schemas and convert the e-file schemas into output e-file schemas; executing a mapping operation to generate an instruction-to-schema mapping by mapping the output tax filing instructions to the output e-file schemas, wherein the output tax filing instructions form a corpus and the output e-file schemas form queries; executing a tax form descriptions operation that generates form descriptions and per-line descriptions of each of the tax forms from the instruction-to-schema mapping using a first generative model for each of the tax forms; receiving a tax article identifying a tax regulation change; executing an impacted forms operation that uses the form descriptions and the identified tax regulation change as inputs to a second generative model that identifies at least one impacted tax form; executing an impacted lines operation that uses a third generative model to identify at least one impacted line from the at least one impacted form; and generating a notification to a user on an interface, the notification including the at least one impacted line in the at least one impacted form. In one aspect of this embodiment, the mapping operation employs a BM25 algorithm to generate the instruction-to-schema mapping. In a variant of this aspect, the BM25 algorithm ranks the output tax filing instructions to generate the instruction-to-schema mapping. In another aspect, the first generative model generates the per-line descriptions in batches of lines for the lines of the tax forms. In another aspect, the one or more processors is further configured to execute a context documents operation that uses article metadata to retrieve only relevant form descriptions from the form description database. In another aspect, the one or more processors is further configured to execute a long article generation operation that uses a fourth generative model to expand the tax article when a length of the tax article is below a predetermined threshold. In a variant of this aspect, the third generative model identifies the at least one impacted line by determining which lines in the per-line descriptions are impacted by the expanded tax article. In another aspect, the impacted forms operation performs a hallucination check by comparing the at least one impacted tax form to a predefined list of tax forms for a jurisdiction and filtering out the at least one impacted tax form when it does not appear on the predefined list of tax forms. In another aspect, the second generative model generates a rationale for identifying the at least one impacted form for display in the notification and assigns a confidence level to the at least one impacted form based on a relevance of the tax regulation change to the at least one impacted form. In yet another aspect, the third generative model generates a rationale for identifying the at least one impacted line for display in the notification and assigns a confidence level to the at least one impacted line based on a relevance of the tax regulation change to the at least one impacted line. In another aspect, the one or more processors is further configured to match historical filings of the user with tax regulation changes using user data, the at least one impacted form and the at least one impacted line.

In yet another embodiment, the present disclosure provides a non-transitory computer-readable medium containing program instructions for causing a computer to perform a method of tax regulatory change management, comprising: receiving tax filing instructions from a tax filing instructions database; receiving e-file schemas of tax forms from a tax form schemas database; executing a text extraction operation to convert the tax filing instructions into output tax filing instructions having a text format; executing a preprocessing operation to append an identifier to each line of the tax forms of the e-file schemas and convert the e-file schemas into output e-file schemas; executing a mapping operation to generate an instruction-to-schema mapping by mapping the output tax filing instructions to the output e-file schemas, wherein the output tax filing instructions form a corpus and the output e-file schemas form queries; executing a tax form descriptions operation that generates form descriptions and per-line descriptions of each of the tax forms from the instruction-to-schema mapping using a first generative model for each of the tax forms; receiving a tax article identifying a tax regulation change; executing an impacted forms operation that uses the form descriptions and the identified tax regulation change as inputs to a second generative model that identifies at least one impacted tax form; executing an impacted lines operation that uses a third generative model to identify at least one impacted line from the at least one impacted form; and generating a notification to a user on an interface, the notification including the at least one impacted line in the at least one impacted form. In one aspect of this embodiment, the impacted forms operation performs a hallucination check by comparing the at least one impacted tax form to a predefined list of tax forms for a jurisdiction and filtering out the at least one impacted tax form when it does not appear on the predefined list of tax forms. In another aspect, the second generative model generates a rationale for identifying the at least one impacted form for display in the notification and assigns a confidence level to the at least one impacted form based on a relevance of the tax regulation change to the at least one impacted form. In another aspect, the third generative model generates a rationale for identifying the at least one impacted line for display in the notification and assigns a confidence level to the at least one impacted line based on a relevance of the tax regulation change to the at least one impacted line.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a block diagram of a system according to one embodiment of the present disclosure;

FIG. 2 is a high-level architecture diagram of a system according to one embodiment of the present disclosure;

FIGS. 3-5 depict a flowchart for a method according to one embodiment of the present disclosure; and

FIG. 6 illustrates a screenshot depicting a notification displayed according to one embodiment of the present disclosure.

### DETAILED DESCRIPTION

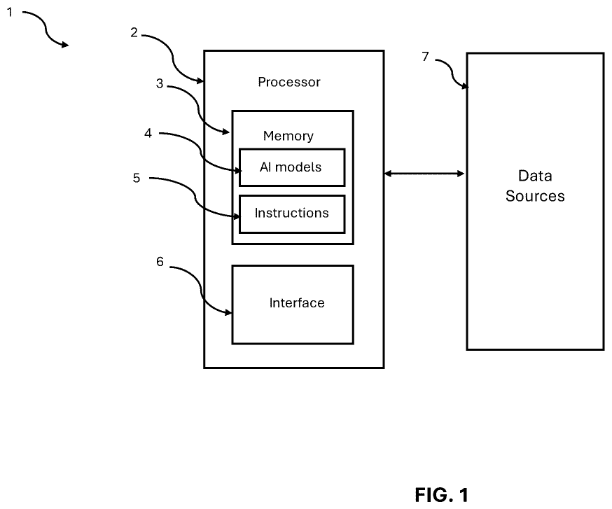

Referring now to FIG. 1, the system 1 generally includes a processor 2 having a memory 3 and a user interface 6. The memory 3 includes a plurality of generative artificial intelligence (“AI”) models 4 and a plurality of instructions 5. The processor 2 is configured to communicate with a plurality of data sources 7. It should be understood that the system 1 may include a plurality of controllers 2 for performing the functions described herein. The processor 2 may communicate with the data sources 7 and/or the user interface 6 via one or more networks (not shown) as is further described below.

As indicated above, traditional methods for staying abreast of tax regulations are inefficient and lack a personalized approach. The present disclosure provides systems and methods to address these challenges by introducing a machine learning-powered solution that automates the generation of tailored tax regulatory change notifications (hereinafter, “the Tax Regulatory Insights (”TRI“) solution”). Unlike existing systems, the TRI solution of the present disclosure goes beyond simple alerts. As is described below, it employs a sophisticated multi-stage pipeline to pinpoint the exact forms and specific lines within those forms impacted by new regulations. This level of granularity ensures that tax professionals receive highly targeted and actionable notifications for their specific clients. The TRI solution leverages tax legislation news content, information retrieval (“IR”) techniques, and state-of-the-art generative Al models 4 to achieve these goals. This robust combination enables efficient and accurate processing of tax-related information.

In general, the TRI solution leverages large language models (“LLMs”) to effectively handle extensive contextual text information, such as filing instructions, to enhance its capabilities. A BM25 algorithm, a well-established probabilistic ranking function used in information retrieval to assess relevance between textual inputs, facilitates data preparation by automating the matching between the e-file schemas and filing instructions. Additionally, the TRI solution protects sensitive taxpayer data. This data remains secure within the tax return preparation software by design, preventing unauthorized access, and is not used to train any machine learning models. The matching service described below, which aligns the output of the TRI solution with the user's tax filings, operates without compromising data privacy. Furthermore, the TRI solution incorporates hallucination checks to mitigate the risk of inaccurate notifications, ensuring that only relevant tax forms are flagged.

Additionally, by explaining generated notifications, the TRI solution offers interpretability and accountability measures. Using prediction confidence levels allows tuning the number of alerts filtered by impact. As such, the TRI solution significantly improves the efficiency and accuracy of tax compliance by seamlessly integrating with tax preparation software, such as Thomson Reuters ONESOURCE Income Tax, GoSystem Tax, Ultra Tax, and the like. This integration may empower tax professionals to save valuable time and resources while ensuring compliance with the latest tax regulations. Thus, besides scalability to a large volume of data, personalization, privacy, and low computational complexity, the TRI solution offers enhanced explainability for compliance applications and prediction confidence.

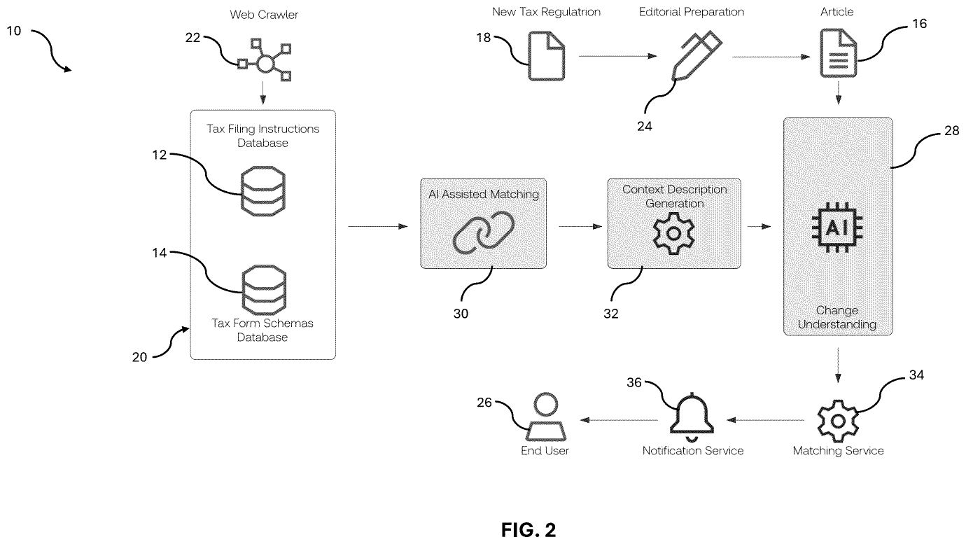

Referring now to FIG. 2, a high-level architecture diagram of a TRI solution 10 according to one embodiment of the present disclosure is shown. Hereinafter, references to the TRI solution 10 performing functions are short-hand for the processor 2 of the system 1 executing the instructions 5 stored the memory 3. Instead of identifying relevant tax change regulations manually, a process that is not only inefficient but is also susceptible to human errors, the TRI solution 10 automates the notification process based on specific user data in a computationally efficient manner without compromising privacy. As is further explained below, the TRI solution 10 blends IR techniques and generative Al models 4 for generating explainable, precise notifications accompanied by rationales and confidence scores to address the inefficiencies and error-proneness of the conventional manual classification process, and leverages publicly available information curated by human editors and annotators.

The inputs to the TRI solution 10 include at least three sources of data: a tax filing instructions database 12, a tax form e-file schemas database 14 and articles 16 about new tax regulations 18. Each of these inputs comprise publicly available information (as represented by data sources 7 in FIG. 1) published by governmental agencies. The tax filing instructions database 12 and the tax form e-file schemas database 14 may be accessible by the processor 2 via the Internet 20. The TRI solution 10 employs one or more web crawlers 22, which are responsible for tracking and downloading information from the tax filing instructions database 12 and the tax form e-file schemas database 14. The articles 16 are tracked and curated by human editors 24. In certain embodiments, the human editors 24 include an editorial team, such as may be provided by Thomson Reuters, to ensure the availability of up-to-date information, which enables high notification relevancy for the end-user 26.

The TRI solution's 10 performance improves with use of the information from the relevant tax filing instructions database 12 and the tax form e-file schemas database 14 in the change understanding block 28. Thus, reliable mapping between the information from the tax form e-file schemas database 14 and the tax filing instructions database 12 is desirable, but it requires human oversight, as a fully automated solution may not guarantee reliability. Nevertheless, the Al-Assisted matching block 30 limits the human workload required.

Following the data collection and matching described above, at the context description generation block 32 the TRI solution 10 prepares the data to create a robust context description for use at the change understanding block 28. This fully automatic process involves formatting the data into a suitable structure, sanitizing the data, and addressing hallucinations generated by the generative models as is further described below.

The output of the change understanding block 28 provides impacted forms and impacted lines within the forms affected by new tax regulations 18. Additionally, the output provides rationale and confidence for the predictions to increase the end user's 26 transparency and trust in the process. The matching service 34 retrieves the past filing data and assesses an impact specific to each user's 26 client using simple rule-based lookups. Client-specific assessments in the memory 3 are stored for alert generation by the notification service 36 as is further described below.

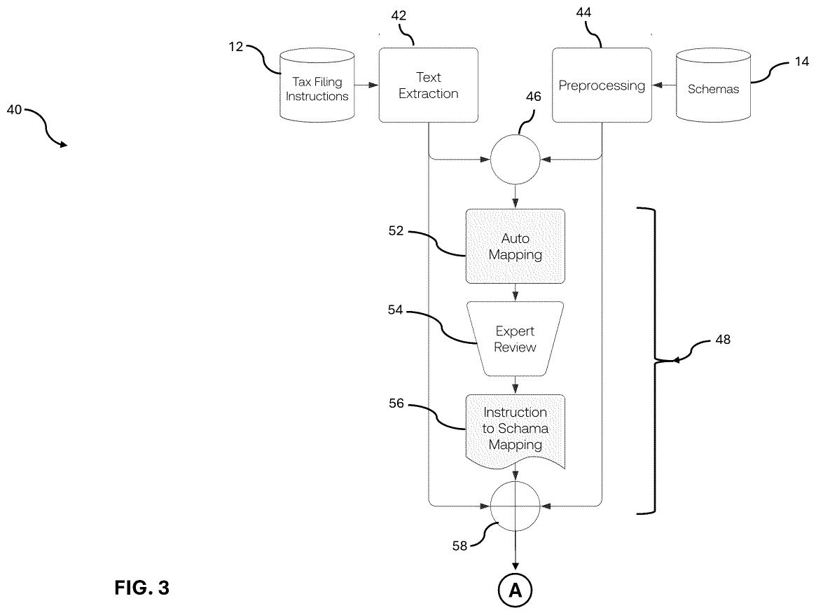

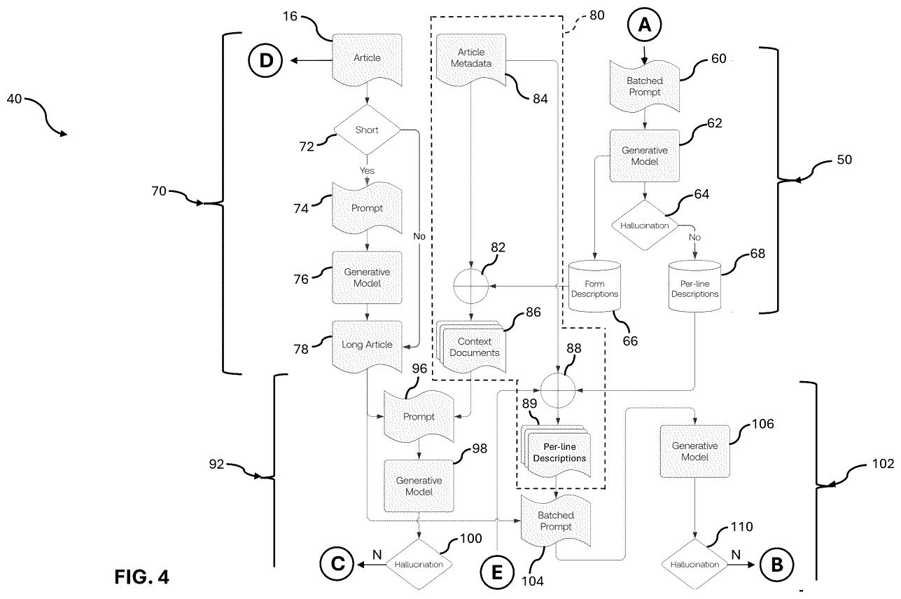

Referring now to FIGS. 3-5, a flowchart is shown depicting a process 40 executed by the TRI solution 10 according to one embodiment of the present disclosure. As shown, data from the tax filing instructions database 12 is provided to a text extraction operation 42 and data from the tax form schemas database 14 is provided to a preprocessing operation 44. The outputs of the text extraction operation 42 and the preprocessing operation 44 are combined at connection block 46. These operations represent the beginning of the data preparation process, during which tax filing instructions, which are publicly available documents (typically in . pdf format) that provide detailed guidance and supplementary instructions for completing one or more specific tax forms, are extracted from the tax filing instructions database 12 and e-filing schemas, which are publicly available XSD files (XML Schema Definition) that define the structure and data elements of electronic tax forms with each field represented by a corresponding tag in the schema, are extracted from the tax form schemas database 14 and processed. The tax filing instructions may be extracted in PDF format, although other formats may be used. At the text extraction operation 42, text extraction is performed to convert the tax filing instructions from their source format (such as, pdf, Word documents, HTML, or other file formats) into plain text format using appropriate extraction libraries or tools, such as PyMuPDF for . pdf files. The e-file schemas are typically stored in the tax form schemas database 14 in the CSV format or the XML format. The preprocessing of the e-files schemas at preprocessing operation 44 involves appending a unique identifier (“ID”) to each line, as some lines lack either a name (or have duplicate names within one form) or a line number, and converting the resulting data to JSON format, which produces a more token compact input version for the mapping operation 48 and the tax form descriptions operation 50 (FIG. 4) described below.

In the mapping operation 48, the BM25 algorithm of a machine-learning auto mapping module 52 is deployed to match the tax filing instructions with the e-file schemas where the former are the corpus and the latter are used as queries (only the line descriptions). The BM25 algorithm is a probabilistic information retrieval technique that ranks documents based upon query relevance. In this application, the tax filing instructions serve as the corpus (i.e., the collection of documents to be searched), while each e-file schema-represented by the concatenated descriptions of all its lines serves as a query. For each e-file schema, the BM25 algorithm ranks the tax filing instruction documents and selects the most relevant one, thereby establishing the connection between individual e-file schemas and their corresponding instructional content. The mapping between these two is seldom one-to-one, as tax filing instructions can contain guidelines for multiple tax forms, or the guidelines for a specific form can be found in various instruction files. Hyperparameters of the BM25 algorithm are tuned using limited gold data mapping provided by in-house experts who have manually mapped a subset of e-file schemas to their corresponding tax filing instructions. Tuning involves adjusting parameters that control how the algorithm weighs term frequency and document length to optimize matching accuracy. The auto mapping module 52 outputs a preliminary tax filing instructions-to-e-file schema map for experts to review (manual expert review block 54). The review at block 54 is needed because the rest of the process (especially the tax form descriptions operation 50) is sensitive to the mapping quality. Fortunately, the review at block 54 need only be conducted annually as amendments to the tax filing instructions and/or the e-file schemas are relatively rare and do not affect the mapping. The instruction to schema mapping from instruction to schema mapping block 56, the extracted tax filing instructions from the text extraction operation 42, and the preprocessed e-file schemas from the preprocessing operation 44 are provided as input to a filtering operation 58.

Referring now to FIG. 4, the output of the filtering operation 58 is received by an optimized batched prompt operation 60 as part of the tax form descriptions operation 50. In general, the tax form descriptions operation 50 takes the relevant and preprocessed tax filing instructions and the e-file schemas based on the mapping produced in the mapping operation 48 and outputs high-level form descriptions and detailed per-line descriptions for each tax form. At the batched prompt operation 60, a batched prompt is input into a generative model 62, the batched prompt comprising relevant field information, the extracted filing instructions, and task instructions for generating enhanced field descriptions. Due to the limited output context window of state-of-the-art generative models, the generative model 62 is instructed to generate line descriptions in batches (e.g., if the form has 100 lines, the generative model 62 is prompted twice to create descriptions for lines 1-50 in the first call and 51-100 in the second call). The generative model 62 is tasked with generating more verbose line descriptions, not other details (i.e., field names, line numbers or IDs). Thus, the hallucination step 64 filters out any output that does not match IDs and field names from the input schema. Finally, the output of the generative model 62 is provided as form descriptions to a form descriptions database 66 and per-line descriptions to a per-line descriptions database 68. For example, a form description may include a comprehensive overview such as: “FormCBT100 is the New Jersey Corporation Business Tax Return used by corporations to report their business income and calculate their tax liability . . . Key features may include reporting of entire net income and allocation to New Jersey, calculation of tax base and applicable tax rates, application of tax credits and surtaxes . . . ” Similarly, a per-line description provides detailed information about a specific field, such as “TaxBase: The Tax Base is the amount of income on which the New Jersey Corporation Business Tax is calculated. It is determined after applying all applicable adjustments, allocations, and deductions to the corporation's entire net income,” or “CorpTransitFee: The Corporate Transit Fee is a 2.5% fee imposed on corporations with taxable net income over $ 10 million for privilege periods beginning on and after Jan. 1, 2024, through December 31, 2028.” The tax form descriptions operation 50 is performed upon the authority issuing new or amended tax filing instructions or e-file schemas.

Still referring to FIG. 4, the articles 16 from the human editors 24 (FIG. 2) are used in a long article generation operation 70. The long article generation operation 70 first decides (at decision block 72) whether the tax news article 16 written by human experts is suitable as an input to the generative model 76 based on the length of the article, wherein articles below a token threshold (e.g., 200 tokens) are identified. If yes, then the generative model 76 is prompted at prompt block 74 to expand such articles by replacing vague language with specific details while preserving the original style and factual accuracy, and outputting a long article at long article block 78. Otherwise, the original article passes through unchanged.

The context documents operation 80 depicted in FIG. 4 performs filtering at filtering block 82 using article metadata 84 to retrieve only relevant form descriptions from the form descriptions database 66 based on the jurisdiction mentioned in the article. For example, if the article mentions only the state of Arizona, the only context documents output by the filtering block 82 to context documents block 86 are for Arizona. Human experts produce the article metadata 84 along with the article by manually associating it with a set of topics and with the jurisdictions relevant to the article. Similarly, line retrieval filtering is performed at filtering block 88 using the per-line descriptions from the per-line descriptions database 68 and the impacted forms 90 generated by the impacted forms operation 92 described below. This filtering ensures that only the lines of the forms previously identified as impacted are considered for the impacted lines operation 102. The result is a listing of per-line descriptions as indicated by the per-line descriptions block 89.

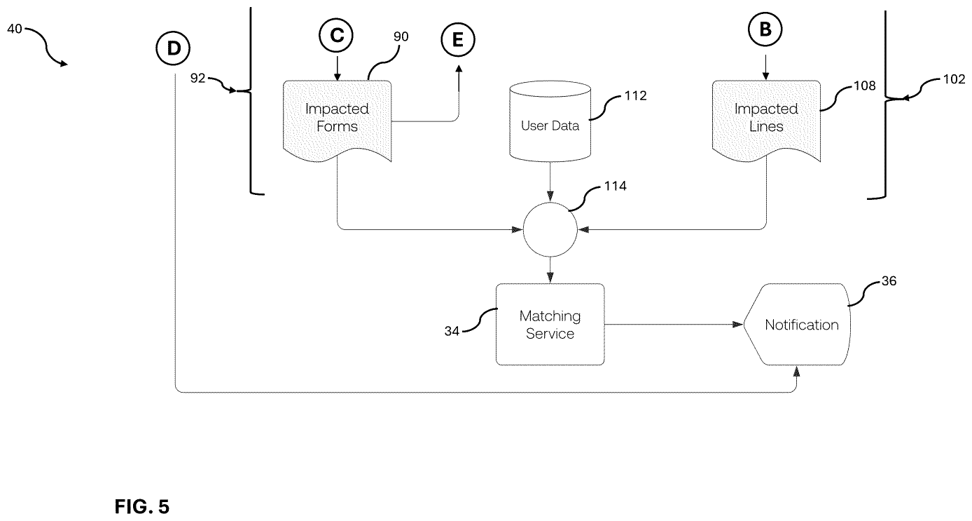

The impacted forms operation 92 constructs a prompt 96 using the tax form descriptions from the context documents 86 and the long articles 78, wherein the prompt 96 instructs the generative model 98 to identify tax forms potentially impacted by the new legislation by comparing the article content with the filing descriptions and assessing the likelihood of impact, resulting in a list of impacted forms 90 (FIG. 5). The impacted forms operation 92 performs a hallucination check at step 100 by comparing the identified forms against a predefined list of forms for the relevant jurisdiction and filtering out any forms not present in the list, thereby removing forms from other jurisdictions or other erroneous model outputs. The list of impacted forms 90 is accompanied by the rationale for the potential impact and a discrete confidence level (e.g., low, medium, or high) assessed by the generative model 98 based on the relevance of the legislative changes to the form. For example, in response to legislation establishing a new corporate transit fee in New Jersey, the generative model 98 may identify Form CBT-100 with a ‘high’ confidence level and a rationale that the form is used to file the New Jersey corporation business tax returns, and the new corporate transit fee would be a component of that business tax.

The impacted lines operation 102 uses the per-line descriptions 89 output by decision block 88 of the context documents operation 80 and the long articles 78 output by the long article generation operation 70 to evaluate the impacted lines within the impacted forms 90 generated by the impacted forms operation 92. In particular, the long articles 78 and the per-line descriptions from the per-line descriptions block 89 are used to generate a batched prompt at a batched prompt block 104, in which the generative model 98 is instructed to determine which of the provided lines are impacted by the regulatory changes described in the long article. The prompting is provided in batches to a generative model 106 with one model call per impacted form 90. If no forms are indicated as impacted, this step is skipped. Like the impacted forms operation 92, the impacted lines 108 (FIG. 5) generated by the impacted lines operation 102 includes the rational and a discrete confidence level, and a hallucination check performed at a hallucination step 110 verifies that the identified lines are present in the given form by comparing them against a predefined list of valid lines for that form, and filtering out any lines not in the list.

Similar to the process described for impacted forms, the generative model 106 provides, for each identified line, a rationale of why that specific line may be impacted by the legislative changes and assigns a confidence level (e.g., low, medium, or high) indicating the likelihood of impact based on the relevance of the legislative changes to that line's purpose and content. For example, continuing with example of the New Jersey corporate transit fee legislation that impacted Form CBT-100 as described above, the generative model 106 may identify “Line 2 (Amount of Tax)” with a rationale that the total tax amount would reflect the addition of the transit fee and assign a “high” confidence level, or “Line 9 (Total Tax and Professional Corporation Fees)” with a rationale that this line aggregates corporate fees and would include the new transit fee, also with a “high” confidence level.

Referring now to FIG. 5, user data is accessed from a user data database 112. As indicated above, the user data is not used to train any generative model or in a feedback loop to improve the performance of the TRI solution 10. The user's historical tax filings are stored securely within the OneSource Income Tax product and used as input to the matching service 34. At a connector block 114, the matching service 34 uses the impacted forms 90, the impacted lines 108 and user data integrated into the tax preparation application, to match user historical filings with tax regulation changes. The rule-based filter of the matching service 34 checks if specific forms or lines were filed by the user by performing a straightforward lookup operation that verifies whether the identified impacted forms and lines are present in the user's prior year filings stored in the OneSource Income Tax product.

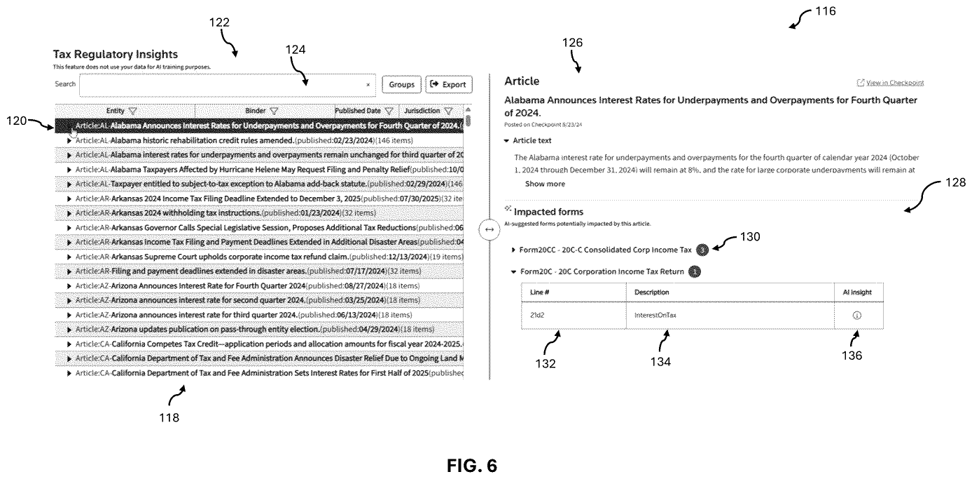

In the final step of the process 40, the TRI solution 10 displays the notification to the user via the notification service 36. Referring now to FIG. 6, a screenshot 116 is provided illustrating a notification displayed by the notification service 36 on the interface 6. The notification displays a listing 118 of regulatory change articles 120 in a tax regulatory insights panel 122. The regulatory change articles 120 are searchable using a search field 124 of the tax regulatory insights panel 122. When an article 120 is selected by an end user 26, an article pane 126 is populated with the article 120 (e.g., the title and the text). An impacted forms pane 128 lists the relevant tax forms 130 and specific line items 132, with descriptions 134 and an information icon 136 usable by the end user 26 to view AI-generated insights related to the specific line item 132.

The TRI solution 10 presents personalized alerts to the user, specifying affected clients and providing the rationale for doing so. The TRI solution 10 shows the article and the list of impacted forms and lines in the notification. Users can review and take action based on the information provided.

As should be apparent from the foregoing, the TRI solution 10 according to embodiments of the present disclosure may significantly advance tax compliance and regulatory change management. By leveraging publicly available content with IR techniques and generative Al models, the TRI solution 10 addresses the challenges tax professionals face in staying informed about and correctly acting upon tax regulatory changes. The TRI solution 10 streamlines the process of identifying relevant changes and provides highly targeted, actionable notifications tailored to specific client needs while maintaining data privacy. The TRI solution 10 also enables more efficient resource allocation, a meaningful benefit in an era where many tax departments face downsizing pressures while still needing to ensure compliance. Beyond classifying new regulatory changes, the TRI solution 10 can be leveraged to audit past filings, uncover mistakes, and mitigate business risks. For example, the TRI solution 10 could be applied retroactively by analyzing historical tax regulations against previously filed returns. Specifically, the system would identify the forms and lines that should have been impacted by the regulations in effect during a given tax year and compare them against what was actually filed, thereby revealing potential discrepancies or missed updates that may require correction. By providing a robust, scalable, and privacy-preserving solution to the challenge of tax regulatory change management, the TRI solution 10 provides a tool for more efficient, accurate, and value-driven tax compliance practices.

One of ordinary skill in the art will realize that the embodiments provided can be implemented in hardware, software, firmware, and/or a combination thereof. For example, the controllers or processors disclosed herein may form a portion of a processing subsystem including one or more computing devices having memory, processing, and communication hardware. The controllers may be a single device or a distributed device, and the functions of the controllers may be performed by hardware and/or as computer instructions on a non-transient computer readable storage medium. For example, the computer instructions or programming code in the controller may be implemented in any viable programming language such as C, C++, C #, python, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features.

Accordingly, the scope of the present disclosure is intended to embrace all such alternatives, modifications, and variations as fall within the scope of the claims, together with all equivalents thereof.

What is claimed is:

1. A method of tax regulatory change management, comprising:
receiving, by one or more processors, tax filing instructions from a tax filing instructions database;
receiving, by the one or more processors, e-file schemas of tax forms from a tax form schemas database;
executing, by the one or more processors, a text extraction operation to convert the tax filing instructions into output tax filing instructions having a text format;
executing, by the one or more processors, a preprocessing operation to append an identifier to each line of the tax forms of the e-file schemas and convert the e-file schemas into output e-file schemas;
executing, by the one or more processors, a mapping operation to generate an instruction-to-schema mapping by mapping the output tax filing instructions to the output e-file schemas, wherein the output tax filing instructions form a corpus and the output e-file schemas form queries;
executing, by the one or more processors, a tax form descriptions operation that generates form descriptions and per-line descriptions of each of the tax forms from the instruction-to-schema mapping using a first generative model for each of the tax forms;
receiving, by the one or more processors, a tax article identifying a tax regulation change;
executing, by the one or more processors, an impacted forms operation that uses the form descriptions and the identified tax regulation change as inputs to a second generative model that identifies at least one impacted tax form;
executing, by the one or more processors, an impacted lines operation that uses a third generative model to identify at least one impacted line from the at least one impacted form; and
generating, by the one or more processors, a notification to a user on an interface, the notification including the at least one impacted line in the at least one impacted form.

2. The method of claim 1, wherein the mapping operation employs a BM25algorithm to generate the instruction-to-schema mapping.

3. The method of claim 2, wherein the BM25 algorithm ranks the output tax filing instructions to generate the instruction-to-schema mapping.

4. The method of claim 1, further comprising executing, by the one or more processors, a filtering operation on the instruction-to-schema mapping, the output tax filing instructions and the output e-file schemas.

5. The method of claim 1, further comprising executing, by the one or more processors, a long article generation operation that uses a fourth generative model to expand the tax article when a length of the tax article is below a predetermined threshold.

6. The method of claim 5, wherein the third generative model identifies the at least one impacted line by determining which lines in the per-line descriptions are impacted by the expanded tax article.

7. The method of claim 1, wherein the impacted forms operation performs a hallucination check by comparing the at least one impacted tax form to a predefined list of tax forms for a jurisdiction and filtering out the at least one impacted tax form when it does not appear on the predefined list of tax forms.

8. The method of claim 1, wherein the second generative model generates a rationale for identifying the at least one impacted form for display in the notification.

9. The method of claim 1, wherein the second generative model assigns a confidence level to the at least one impacted form based on a relevance of the tax regulation change to the at least one impacted form.

10. The method of claim 1, wherein the third generative model generates a rationale for identifying the at least one impacted line for display in the notification.

11. The method of claim 1, wherein the third generative model assigns a confidence level to the at least one impacted line based on a relevance of the tax regulation change to the at least one impacted line.

12. The method of claim 1, wherein the notification includes a listing of searchable tax articles in a tax regulation insights panel.

13. The method of claim 12, wherein when a tax article in the tax regulation insights panel is selected by the user, a title and text of the selected tax article are displayed in an article pane of the notification.

14. A system for tax regulatory change management, comprising:
a memory including a plurality of generative models and a plurality of instructions;
one or more processors coupled to the memory and configured to execute the instructions to perform a plurality of functions, including:
receiving tax filing instructions from a tax filing instructions database;
receiving e-file schemas of tax forms from a tax form schemas database;
executing a text extraction operation to convert the tax filing instructions into output tax filing instructions having a text format;
executing a preprocessing operation to append an identifier to each line of the tax forms of the e-file schemas and convert the e-file schemas into output e-file schemas;
executing a mapping operation to generate an instruction-to-schema mapping by mapping the output tax filing instructions to the output e-file schemas, wherein the output tax filing instructions form a corpus and the output e-file schemas form queries;
executing a tax form descriptions operation that generates form descriptions and per-line descriptions of each of the tax forms from the instruction-to-schema mapping using a first generative model for each of the tax forms;
receiving a tax article identifying a tax regulation change;
executing an impacted forms operation that uses the form descriptions and the identified tax regulation change as inputs to a second generative model that identifies at least one impacted tax form;
executing an impacted lines operation that uses a third generative model to identify at least one impacted line from the at least one impacted form; and
generating a notification to a user on an interface, the notification including the at least one impacted line in the at least one impacted form.

15. The system of claim 14, wherein the mapping operation employs a BM25 algorithm to generate the instruction-to-schema mapping.

16. The system of claim 15, wherein the BM25 algorithm ranks the output tax filing instructions to generate the instruction-to-schema mapping.

17. The system of claim 14, wherein the impacted forms operation performs a hallucination check by comparing the at least one impacted tax form to a predefined list of tax forms for a jurisdiction and filtering out the at least one impacted tax form when it does not appear on the predefined list of tax forms.

18. The system of claim 14, wherein the second generative model generates a rationale for identifying the at least one impacted form for display in the notification and assigns a confidence level to the at least one impacted form based on a relevance of the tax regulation change to the at least one impacted form.

19. The system of claim 14, wherein the third generative model generates a rationale for identifying the at least one impacted line for display in the notification and assigns a confidence level to the at least one impacted line based on a relevance of the tax regulation change to the at least one impacted line.

20. A non-transitory computer-readable medium containing program instructions for causing a computer to perform a method of tax regulatory change management, comprising:
receiving tax filing instructions from a tax filing instructions database;
receiving e-file schemas of tax forms from a tax form schemas database;
executing a text extraction operation to convert the tax filing instructions into output tax filing instructions having a text format;
executing a preprocessing operation to append an identifier to each line of the tax forms of the e-file schemas and convert the e-file schemas into output e-file schemas;
executing a mapping operation to generate an instruction-to-schema mapping by mapping the output tax filing instructions to the output e-file schemas, wherein the output tax filing instructions form a corpus and the output e-file schemas form queries;
executing a tax form descriptions operation that generates form descriptions and per-line descriptions of each of the tax forms from the instruction-to-schema mapping using a first generative model for each of the tax forms;
receiving a tax article identifying a tax regulation change;
executing an impacted forms operation that uses the form descriptions and the identified tax regulation change as inputs to a second generative model that identifies at least one impacted tax form;
executing an impacted lines operation that uses a third generative model to identify at least one impacted line from the at least one impacted form; and
generating a notification to a user on an interface, the notification including the at least one impacted line in the at least one impacted form.
